(19) United States
(12) Patent Application Publication
(10) Pub. No.: US 2024/0384055 A1
(43) Pub. Date: Nov. 21, 2024

(54) GRAPHENE OXIDE (GO)-MODIFIED STYRENE-ACRYLIC PICKERING EMULSION AND COMPOSITE EMULSION, AND PREPARATION METHODS AND USE

(71) Applicant: QINGDAO UNIVERSITY OF TECHNOLOGY, Qingdao, Shandong (CN)

(72) Inventors: Dongshuai HOU, Qingdao (CN); Cong WU, Qingdao (CN); Bing YIN, Qingdao (CN); Shaochun LI, Qingdao (CN); Xinpeng WANG, Qingdao (CN); Pan WANG, Qingdao (CN)

(73) Assignee: QINGDAO UNIVERSITY OF TECHNOLOGY, Qingdao, Shandong (CN)

(21) Appl. No.: 18/035,093

(22) PCT Filed: Jan. 19, 2022
(86) PCT No.: PCT/CN2022/072648

§ 371 Date: Aug. 5, 2024

(30) Foreign Application Priority Data
Dec. 28, 2021 (CN) 202111624818.7

(51) Int. Cl. C08K 3/04; C08F 2/22; C08F 220/18

(52) U.S. Cl. CPC C08K 3/042; C08F 2/22; C08F 220/18

(57) ABSTRACT

The present disclosure relates to the technical field of protective coatings, and provides a graphene oxide (GO)-modified styrene-acrylic Pickering emulsion and a composite emulsion, and preparation methods and use. In the present disclosure, GO is added during polymerization of a styrene-acrylic monomer, and the GO is attached to an interface of a styrene-acrylic core while forming the styrene-acrylic core; and the GO is “stitched” at the interface of the styrene-acrylic core by a silane coupling agent, thus giving the GO a better dispersion effect. After adding a shell phase emulsion, a part of the styrene-acrylic core that is not completely wrapped by a GO sheet may be grafted with a shell phase, and cross-linking between a core phase and the shell phase can further enhance a steric stability of the GO; and the GO can fully connect the styrene-acrylic core with a siloxane shell, improving the molecular configuration of a siloxane component. In the composite emulsion, GO has desirable dispersibility and is not easy to agglomerate, such that the composite emulsion has an excellent performance and can significantly improve the durability of a cement-based material.

The present application claims priority to Chinese Patent Application No. 202111624818.7 filed to the China National Intellectual Property Administration (CNIPA) on Dec. 28, 2021 and entitled “GRAPHENE OXIDE (GO)-MODIFIED STYRENE-ACRYLIC PICKERING EMULSION AND COMPOSITE EMULSION, AND PREPARATION METHODS AND USE”, which is incorporated herein by reference in its entirety.

### TECHNICAL FIELD

The present disclosure relates to the technical field of protective coatings, in particular to a graphene oxide (GO)-modified styrene-acrylic Pickering emulsion and a composite emulsion, and preparation methods and use.

### BACKGROUND

Concrete is the most widely used cement-based engineering building material, and the durability of cement-based materials directly determines the safety and reliability of concrete structures. In the coastal environment with high chloride ion content, the erosion of cement matrix by chloride ions is a main reason for the performance deterioration of concrete structures.

Surface treatment of cement matrix with composite polymer-based coatings can improve the corrosion resistance of concrete structures, which is an efficient, convenient, and low-cost protective measure. Styrene-acrylic coating (styrene-acrylate) and silane are the two most commonly-used polymeric anti-corrosion coatings. Styrene-acrylic coatings have desirable chemical corrosion resistance and high weather resistance, and can form a stable waterproof and corrosion-resistant protective layer on the surface of cement-based materials; silane coatings have excellent hydrophobicity, desirable levelling properties, and strong permeability, which are suitable for various types of cement-based materials. Styrene-acrylate and silane are prepared into a composite anti-corrosion emulsion with a core-shell structure, which can give full play to the protective performance of styrene-acrylic component and the hydrophobic effect of siloxane component, thereby making up for the weak bonding performance of styrene-acrylic coating and the poor anti-aging performance of silane coating.

Traditional core-shell emulsions are prepared by emulsifiers, and it is difficult for the core phase and the shell phase to form orderly and stable graft layer and assembly structure, greatly limiting the further development of core-shell emulsions. Graphene oxide (GO), as a two-dimensional carbon nanomaterial with rich active oxygen-containing functional groups on the surface, can be covalently bonded to various polymer molecules to play a role in chemical modification and performance regulation of polymer coatings. Through in-situ polymerization, sol-gel method, physical blending, and intercalation and other methods, GO can construct an ideal molecular configuration for polymer molecules, and enhance the coordination performance of components in the composite coating. However, in the GO-modified polymer coatings prepared by these traditional methods, GO sheets are mostly in a disordered and disordered spatial state, showing a poor modification effect on the polymer components. Moreover, the GO sheets are extremely prone to aggregation, thereby adversely affecting the stability and film-forming properties of the composite coatings.

### SUMMARY

In view of this, an objective of the present disclosure is to provide a GO-modified styrene-acrylic Pickering emulsion and a composite emulsion, and preparation methods and use. In the GO-modified styrene-acrylic Pickering emulsion, GO is distributed orderly and is not easy to agglomerate. The composite emulsion with a core-shell structure prepared by the GO has excellent stability, film-forming property, water resistance, corrosion resistance, ion penetration resistance, aging resistance, and mechanical properties. The composite emulsion conducts a surface treatment on a cement matrix, so as to significantly improve the durability of a concrete structure.

To achieve the above objective of the present disclosure, the present disclosure provides the following technical solutions.

The present disclosure provides a preparation method of a GO-modified styrene-acrylic Pickering emulsion, including the following steps:
mixing a GO buffer with a styrene-acrylic monomer mixture to conduct first ultrasonic dispersion, and mixing an obtained emulsion with a silane coupling agent to conduct second ultrasonic dispersion, to obtain the GO-modified styrene-acrylic Pickering emulsion; where the GO buffer includes GO, water, and a pH buffer; and the styrene-acrylic monomer mixture includes water, an initiator, styrene, and an acrylate monomer.

Preferably, the styrene-acrylic monomer mixture has 0.3% to 0.7% of the initiator, 10% to 30% of the styrene, and 60% to 90% of the acrylate monomer by mass fraction.

Preferably, in the styrene-acrylic monomer mixture, the initiator is one or more selected from the group consisting of a persulfate and an azo initiator.

Preferably, the GO buffer has the GO with a mass 1% to 10% that of the styrene-acrylic monomer mixture and water with a mass 60% to 150% that of the styrene-acrylic monomer mixture; and
the GO buffer has a pH value of 7 to 8.5.

Preferably, the pH buffer is one or more selected from the group consisting of sodium bicarbonate, sodium carbonate, sodium hydrogen phosphate, a Barbitone buffer, Trometamol, and a glycerophosphate buffer.

Preferably, the first ultrasonic dispersion is conducted at 30° C. to 60° C. for 1 h to 3 h.

Preferably, the second ultrasonic dispersion is conducted at 55° C. to 75° C. for 0.5 h to 2 h.

The present disclosure further provides a GO-modified styrene-acrylic Pickering emulsion prepared by the preparation method, having a GO-modified styrene-acrylic Pickering structure, and including a styrene-acrylic core and GO wrapped at an outer interface of the styrene-acrylic core, where the GO is coupled by a coupling agent.

The present disclosure further provides preparation method of a GO-modified styrene-acrylic-siloxane Pickering composite emulsion, including the following steps:
mixing a shell phase emulsion, the GO-modified styrene-acrylic Pickering emulsion, and an initiator aqueous solution, and conducting polymerization to obtain the GO-modified styrene-acrylic-siloxane Pickering composite emulsion; where the shell phase emulsion includes a silane monomer, an acrylate functional monomer, an emulsifier, and water.

Preferably, the shell phase emulsion has 20% to 50% of the silane monomer by mass fraction; the acrylate functional monomer has a mass 10% to 50% that of the silane monomer, and the emulsifier has a mass 2% to 5% a total mass of the silane monomer and the acrylate functional monomer.

Preferably, a preparation method of the shell phase emulsion includes: mixing the silane monomer, the acrylate functional monomer, and the emulsifier with water, and stirring at a low temperature of 30° C. to 50° C. and a high speed of 800 r/min to 1,200 r/min to obtain the shell phase emulsion.

Preferably, the silane monomer is a long-chain hydrocarbyl silane; and in the long-chain hydrocarbyl silane, a hydrocarbyl group has 4 to 18 of carbon atoms.

Preferably, the long-chain hydrocarbyl silane is one or more selected from the group consisting of n-butyltriethoxysilane, n-octyltrimethoxysilane, n-octyltriethoxysilane, dodecyltrimethoxysilane, and dodecyltriethoxysilane.

Preferably, the acrylate functional monomer includes hydroxyethyl acrylate and/or hydroxypropyl acrylate.

Preferably, the emulsifier is one or more selected from the group consisting of OP-10, Span 80, sodium dodecyl sulfate, sodium dodecyl sulfonate, and sodium dodecyl benzenesulfonate.

Preferably, the GO-modified styrene-acrylic Pickering emulsion and the shell phase emulsion have a mass ratio of 1:(1-5).

Preferably, in the initiator aqueous solution, an initiator has a mass 0.2% to 0.5% that of the shell phase emulsion.

Preferably, the polymerization is conducted at a high temperature of 80° C. to 85° C. under stirring at a low speed of 100 r/min to 300 r/min for 1 h to 3 h.

Preferably, the preparation method further includes the following steps after the polymerization: conducting low-speed stirring and ultrasonic dispersion 3 to 6 repetitions on the composite emulsion, where one time of the low-speed stirring and one time of the ultrasonic dispersion are counted as one repetition.

The present disclosure further provides a GO-modified styrene-acrylic-siloxane Pickering composite emulsion prepared by the preparation method, having a core-shell structure, and including a shell structure, a core structure, and an intermediate transition layer connecting the shell structure and the core structure, where the shell structure is a siloxane polymer, and the core structure is a GO-modified styrene-acrylic Pickering structure; and the intermediate transition layer is a polymer formed from the acrylate functional monomer.

The present disclosure further provides use of the GO-modified styrene-acrylic-siloxane Pickering composite emulsion in anticorrosion of a cement-based material.

The present disclosure provides a preparation method of a GO-modified styrene-acrylic Pickering emulsion, including the following steps: mixing a GO buffer with a styrene-acrylic monomer mixture to conduct first ultrasonic dispersion, and mixing an obtained emulsion with a silane coupling agent to conduct second ultrasonic dispersion, to obtain the GO-modified styrene-acrylic Pickering emulsion; where the GO buffer includes GO, water, and a pH buffer; and the styrene-acrylic monomer mixture includes water, an initiator, styrene, and an acrylate monomer.

In the present disclosure, the GO buffer and the styrene-acrylic monomer mixture are mixed for the first ultrasonic dispersion. In the first ultrasonic dispersion, styrene-acrylic monomers are polymerized to form a styrene-acrylic core, and GO is attached to an interface of the styrene-acrylic core, and a silane coupling agent is added for the second ultrasonic dispersion. In the second ultrasonic dispersion, the GO is coupled under an action of the silane coupling agent, such that the GO is “stitched” at the interface of the styrene-acrylic core; as a result, the GO exhibits orderly dispersion, which endows the GO with a better dispersion effect, and enhances its performance regulation and modification effects. The GO-modified styrene-acrylic Pickering emulsion can be further prepared into a composite emulsion with a core-shell structure by adding a shell phase emulsion; the GO at the interface of the styrene-acrylic core can maintain a desirable dispersion state no matter in the subsequent composite emulsion synthesis or after the formation of a composite emulsion film.

The present disclosure further provides preparation method of a GO-modified styrene-acrylic-siloxane Pickering composite emulsion, including the following steps: mixing a shell phase emulsion, the GO-modified styrene-acrylic Pickering emulsion, and an initiator aqueous solution, and conducting polymerization to obtain the GO-modified styrene-acrylic-siloxane Pickering composite emulsion; where the shell phase emulsion includes a silane monomer, an acrylate functional monomer, an emulsifier, and water. In the present disclosure, the shell phase emulsion is added to the GO-modified styrene-acrylic Pickering emulsion for polymerization to form a composite emulsion with a core-shell structure. After adding a shell phase emulsion, in the GO-modified styrene-acrylic Pickering emulsion, a part of the styrene-acrylic core that is not completely wrapped by a GO sheet may be grafted with a shell phase, and cross-linking between a core phase and the shell phase can also further enhance a steric stability of the GO; and the GO can fully connect the styrene-acrylic core structure with a siloxane shell structure, improving the molecular configuration of a siloxane component and enhancing an ability to regulate a chemical activity of siloxane molecules.

In the present disclosure, the GO-modified styrene-acrylic-siloxane Pickering composite emulsion has excellent film-forming properties. The principle is as follows: the GO sheet contains both hydrophilic groups and hydrophobic groups, which can effectively replace emulsifier molecules in the composite emulsion; accordingly, the GO sheet becomes a stable transition layer between styrene-acrylic molecular micelles and solvent water molecules, thereby reducing the adverse effects of residual emulsifier components on a film-forming process. In addition, GO enhanced binding performance and synergistic performance between the styrene-acrylic component and the siloxane component, which is beneficial to the homogeneity and stability of a coating system during the film formation.

In the present disclosure, the GO-modified styrene-acrylic-siloxane Pickering composite emulsion has excellent hydrophobic and waterproof properties. The principle is as follows: GO can improve a molecular configuration of siloxane in the shell structure, make the siloxane molecules orderly and tightly grafted on a core phase inside the composite emulsion, and make hydrophobic alkane chains in the siloxane molecules fully stretched and aligned. The GO can also enhance the dispersion and stability of the styrene-acrylic core structure, thereby fully improving the water resistance of the styrene-acrylic component and the hydrophobic property of the siloxane component, as well as improving the hydrophobicity and stability of the film formation. In addition, when the emulsion is formed into a film, GO sheets can not only deposit on a surface of the cement matrix to form an orderly-distributed rough surface, but also promote a secondary hydration reaction between siloxane molecules and concrete hydration products, thereby inhibiting external moisture from entering the cracks and capillary channels inside the concrete.

In the present disclosure, the GO-modified styrene-acrylic-siloxane Pickering composite emulsion coating has excellent resistance to chloride and sulfate erosion. The principle is as follows: GO can improve a cross-linking degree of the silane emulsion, and weaken the diffusion and transmission of chloride ions and sulfate ions on the surface and inside the capillary channels of concrete. The GO enhances the cross-linking and bonding between the styrene-acrylic micelles and the siloxane components, and improves a shielding performance of the composite coating against aggressive ions; the GO also has a blocking effect on erosive ions, hindering and prolonging the transmission path of erosive ions. In addition, the GO can further improve an electrochemical performance of the emulsion and enhance chemical corrosion resistance of the coating.

In the present disclosure, the GO-modified styrene-acrylic-siloxane Pickering composite emulsion coating has an excellent anti-aging performance. The principle is as follows: with the evaporation of free water and the penetration of small-sized latex particles during the film formation, GO may continue to deposit and adhere to the surface of the substrate, forming a complete heat-resistant and radiation-resistant reflective layer. Meanwhile, GO can promote the formation of strong cross-linking and bonding between styrene-acrylic molecules and siloxane molecules, and significantly increase a cross-linking density of the transition layer in the Pickering composite emulsion, which is beneficial to the absorption and dissipation of external energy by the composite coating, thereby improving aging resistance of the coating.

### BRIEF DESCRIPTION OF THE DRAWINGS

FIG. 1 shows optical photographs of an apparent form of composite emulsions obtained in Example 1 to 4 and Comparative Examples 1 to 3;

FIG. 2 shows metallographic microscope scanning images of the composite emulsions obtained in Example 1 to 4 and Comparative Examples 1 to 3;

FIG. 3 shows test figures of a static contact angle of coatings that the composite emulsions obtained in Example 1 to 4 and Comparative Examples 1 to 3 forms on a cement specimen surface;

FIG. 4 shows a static capillary water absorption curve of a concrete specimen after adopting the composite emulsions obtained in Example 1 to 4 and Comparative Examples 1 to 3 to conduct a surface treatment;

FIG. 5 shows a calculation fitting diagram of an erosion rate on concrete by chloride ions after surface treatment by the composite emulsions obtained in Example 1 to 4 and Comparative Examples 1 to 3;

FIG. 6 shows a calculation fitting diagram of an erosion rate on concrete by sulfate ions after surface treatment by the composite emulsions obtained in Example 1 to 4 and Comparative Examples 1 to 3;

FIG. 7 shows a SEM test figure of latex films formed by the composite emulsions in Examples 1 to 2;

FIG. 8 shows a SEM test figure of latex films formed by the composite emulsions in Examples 3 to 4;

FIG. 9 shows a SEM test figure of latex films formed by the emulsions in Comparative Examples 1 to 2;

FIG. 10 shows a SEM test figure of a latex film formed by the emulsion in Comparative Examples 3;

FIG. 11 shows an atomic force microscope (AFM) test figures of latex films formed by the composite emulsions in Examples 1 to 2;

FIG. 12 shows an AFM test figures of latex films formed by the composite emulsions in Examples 3 to 4;

FIG. 13 shows an AFM test figure of latex films formed by the emulsions in Comparative Examples 1 to 2; and

FIG. 14 shows an AFM test figure of a latex film formed by the emulsion in Comparative Examples 3.

### DETAILED DESCRIPTION OF THE EMBODIMENTS

The present disclosure provides a preparation method of a GO-modified styrene-acrylic Pickering emulsion, including the following steps:
mixing a GO buffer with a styrene-acrylic monomer mixture to conduct first ultrasonic dispersion, and mixing an obtained emulsion with a silane coupling agent to conduct second ultrasonic dispersion, to obtain the GO-modified styrene-acrylic Pickering emulsion; where the GO buffer includes GO, water, and a pH buffer; and the styrene-acrylic monomer mixture includes water, an initiator, styrene, and an acrylate monomer.

In the present disclosure, the styrene-acrylic monomer mixture has preferably 0.3% to 0.7%, more preferably 0.4% to 0.6% of the initiator, preferably 10% to 30%, more preferably 15% to 25% of the styrene, and preferably 60% to 90% of the acrylate monomer by mass fraction; the styrene-acrylic core structure obtained by the above ratio has a higher glass transition temperature, ensuring that the GO sheets have a higher spatial stability.

In the present disclosure, the initiator is preferably one or more selected from the group consisting of a persulfate and an azo initiator; the persulfate is preferably one or more selected from the group consisting of sodium persulfate, ammonium persulfate, and potassium persulfate; the azo initiator includes preferably azobisisobutyronitrile and/or 2,2-azobis(2-methylbutyronitrile) (AMBN); the acrylate monomer is preferably one or more selected from the group consisting of methyl acrylate, methyl methacrylate, ethyl acrylate, butyl acrylate, butyl methacrylate, acrylic acid, and methacrylic acid; and water is preferably deionized water.

In a specific example of the present disclosure, preferably, the initiator is added to deionized water to obtain an initiator aqueous solution; the styrene and the acrylate monomer are mixed to obtain a mixed monomer; and the mixed monomer is added into the initiator aqueous solution to obtain the styrene-acrylic monomer mixture.

In the present disclosure, a preparation method of the GO buffer includes preferably the following steps: adding GO to deionized water to conduct ultrasonic dispersion for preferably 1 h to 4 h, to obtain a GO aqueous solution; and adding a pH buffer to the GO aqueous solution to obtain the GO buffer.

In the present disclosure, the pH buffer is preferably one or more selected from the group consisting of sodium bicarbonate, sodium carbonate, sodium hydrogen phosphate, a Barbitone buffer, Trometamol, and a glycerophosphate buffer.

In the present disclosure, the GO buffer has GO with a mass preferably 1% to 10%, more preferably 3% to 8% that of the styrene-acrylic monomer mixture, and water with a mass preferably 60% to 150%, more preferably 80% to 120% that of the styrene-acrylic monomer mixture; and the GO buffer has a pH value of preferably 7 to 8.5, and the pH buffer is used in an amount to adjust the pH value of the GO buffer to the above range. In the subsequent polymerization, the initiator can reduce the pH value of the system when it initiates the formation of free radicals; the pH buffer adjusts the GO buffer to weak alkalinity, keeping the emulsion neutral in the subsequent addition polymerization, which is beneficial to the progress of the reaction.

In the subsequent polymerization, a GO buffer is mixed with a styrene-acrylic monomer mixture to conduct first ultrasonic dispersion, and an obtained dispersion is mixed with a silane coupling agent to conduct second ultrasonic dispersion, to obtain the GO-modified styrene-acrylic Pickering emulsion. Preferably, the styrene-acrylic monomer mixture is slowly added to the GO buffer, and then the first ultrasonic dispersion is conducted; the first ultrasonic dispersion is conducted at preferably 30° C. to 60° C. for preferably 1 h to 3 h, more preferably 1.5 h to 2.5 h; in a specific example, preferably, after the GO buffer and the styrene-acrylic monomer mixture are mixed, a mixture is stirred at 30° C. to 60° C. for 30 min, and then the first ultrasonic dispersion is conducted. During the first ultrasonic dispersion, the styrene and acrylate monomer are polymerized to form a styrene-acrylic polymer (the styrene-acrylic core), and the GO is attached to a surface of the styrene-acrylic core.

In the present disclosure, after the first ultrasonic dispersion is completed, preferably, the silane coupling agent is added dropwise to an obtained emulsion, and then the second ultrasonic dispersion is conducted. The silane coupling agent is preferably one or more selected from the group consisting of KH-550, KH-560, and KH-570; the silane coupling agent has a mass preferably 2% to 20% that of GO in the emulsion obtained by the first ultrasonic dispersion; and the second ultrasonic dispersion is conducted at preferably 55° C. to 75° C., more preferably 60° C. to 70° C. for preferably 0.5 h to 2 h, more preferably 1 h to 1.5 h. In a specific example, preferably after mixing the emulsion obtained by the first ultrasonic dispersion and the silane coupling agent, a mixture is stirred at 55° C. to 75° C. for 20 min, and then the second ultrasonic dispersion is conducted. In the second ultrasonic dispersion, GO is coupled under an action of the silane coupling agent, such that GO is “stitched” at an interface of the styrene-acrylic core, thus giving GO a better dispersion effect.

The present disclosure further provides a GO-modified styrene-acrylic Pickering emulsion prepared by the preparation method, having a GO-modified styrene-acrylic Pickering structure, and including a styrene-acrylic core and GO wrapped at an outer interface of the styrene-acrylic core, where the GO is coupled by a coupling agent. In the present disclosure, in the GO-modified styrene-acrylic Pickering emulsion, GO has desirable dispersion and is not easy to agglomerate, and can be used to prepare a composite emulsion with a core-shell structure; the GO at the interface of the styrene-acrylic core can maintain a desirable dispersion state no matter in the subsequent composite emulsion synthesis or after the formation of a composite emulsion film.

The present disclosure further provides preparation method of a GO-modified styrene-acrylic-siloxane Pickering composite emulsion, including the following steps:
mixing a shell phase emulsion, the GO-modified styrene-acrylic Pickering emulsion, and an initiator aqueous solution, and conducting polymerization to obtain the GO-modified styrene-acrylic-siloxane Pickering composite emulsion; where the shell phase emulsion includes a silane monomer, an acrylate functional monomer, an emulsifier, and water.

In the present disclosure, the silane monomer is a long-chain hydrocarbyl silane; and in the long-chain hydrocarbyl silane, a hydrocarbyl group has 4 to 18 of carbon atoms. Specifically, the long-chain hydrocarbyl silane is one or more selected from the group consisting of n-butyltriethoxysilane, n-octyltrimethoxysilane, n-octyltriethoxysilane, dodecyltrimethoxysilane, and dodecyltriethoxysilane; the acrylate functional monomer includes hydroxyethyl acrylate and/or hydroxypropyl acrylate; the acrylate functional monomer is used to provide crosslinking points, promote the polymerization between silane molecules, and appropriately increase a viscosity of the emulsion; the emulsifier is one or more selected from the group consisting of OP-10, Span 80, sodium dodecyl sulfate, sodium dodecyl sulfonate, and sodium dodecyl benzenesulfonate; the water is preferably deionized water.

In the present disclosure, the shell phase emulsion has preferably 20% to 50% of the silane monomer by mass fraction; the acrylate functional monomer has a mass preferably 10% to 50%, more preferably 15% to 40% that of the silane monomer; and the emulsifier is added at preferably 2% to 5%, more preferably 3% to 4% a total mass of the silane monomer and the acrylate functional monomer.

In the present disclosure, a preparation method of the shell phase emulsion includes preferably: mixing the silane monomer, the acrylate functional monomer, and the emulsifier with water and stirring at a low temperature and a high speed to obtain the shell phase emulsion; in a specific example, preferably the emulsifier is added into water to obtain an emulsifier aqueous solution; and the silane monomer and the acrylate functional monomer are added into the emulsifier aqueous solution and stirred at a low temperature and a high speed. The low-temperature and high-speed stirring is conducted at preferably 30° C. to 50° C., more preferably 35° C. to 45° C. and preferably 800 r/min to 1200 r/min, more preferably 900 r/min to 1000 r/min. The preparation of the shell phase emulsion under the low-temperature and high-speed stirring can pre-polymerize the siloxane molecules to form a molecular network structure with a low molecular weight, which is beneficial to the cross-linking of a siloxane molecular layer on the styrene-acrylic core structure and the improvement of a chemical stability of the surface hydrophobic layer.

In the present disclosure, the shell phase emulsion, the GO-modified styrene-acrylic Pickering emulsion, and an initiator aqueous solution are mixed, and polymerization is conducted to obtain the GO-modified styrene-acrylic-siloxane Pickering composite emulsion. The GO-modified styrene-acrylic Pickering emulsion and the shell phase emulsion have a mass ratio of preferably 1:(1-5), more preferably 1:(2-4); in the initiator aqueous solution, the initiator has a mass preferably 0.2% to 0.5%, more preferably 0.3% to 0.4% that of the shell phase emulsion; an initiator in the initiator aqueous solution is consistent with the above-mentioned scheme, which is not repeated here; the polymerization is conducted preferably under high-temperature and low-speed stirring; the high-temperature and low-speed stirring is conducted at preferably 80° C. to 85° C., more preferably 82° C. to 83° C. and preferably 100 r/min to 300 r/min, more preferably 150 r/min to 250r/min for preferably 1 h to 3 h, more preferably 1.5 h to 2.5 h. Preferably, the polymerization is conducted under high-temperature and low-speed stirring to avoid agglomeration and gelation during the polymerization. After the low-temperature and high-speed stirring is completed, preferably an obtained reaction liquid is subjected to heat preservation for 2 h to ensure a complete reaction, and then slowly cooled to 30° C. to obtain the GO-modified styrene-acrylic-siloxane Pickering composite emulsion. During the polymerization, the silane monomer and the acrylate functional monomer are polymerized to form a shell layer, which is coated on a surface of the styrene-acrylic Pickering structure; meanwhile, a part of the styrene-acrylic Pickering structure that is not completely wrapped by the GO sheet is grafted with the shell structure to enhance a stability of the composite emulsion.

The preparation method further includes the following steps after the polymerization: conducting low-speed stirring and ultrasonic dispersion preferably 3 to 6 repetitions, more preferably 4 to 5 repetitions on the composite emulsion, where one time of the low-speed stirring and one time of the ultrasonic dispersion are counted as one repetition; the low-speed stirring is conducted at preferably 100 r/min to 200 r/min, more preferably 130 r/min to 150 r/min; each low-speed stirring is conducted for preferably 5 min to 60 min, and each ultrasonic dispersion is conducted for preferably 20 min to 60 min, more preferably 30 min to 50 min. The repeated low-speed stirring and ultrasonic dispersion can further improve the dispersibility of the composite emulsion, and further increase a graft crosslinking ratio between the shell structure and the GO sheet in the composite emulsion.

The present disclosure further provides a GO-modified styrene-acrylic-siloxane Pickering composite emulsion prepared by the preparation method, having a core-shell structure, and including a shell structure, a core structure, and an intermediate transition layer connecting the shell structure and the core structure, where the shell structure is a siloxane polymer, and the core structure is a GO-modified styrene-acrylic Pickering structure; and the intermediate transition layer is a polymer formed from the acrylate functional monomer. In the composite emulsion provided by the present disclosure, the GO has desirable dispersibility and is not easy to agglomerate; and the composite emulsion has excellent stability, film-forming property, water resistance, corrosion resistance, ion penetration resistance, aging resistance, and mechanical properties.

The present disclosure further provides use of the GO-modified styrene-acrylic-siloxane Pickering composite emulsion in anticorrosion of a cement-based material. In the present disclosure, the cement-based material is preferably a concrete building structure; there is no special requirement for a specific method of the use, and the method well known to those skilled in the art can be used. Specifically, the composite emulsion can be coated on a surface of the cement matrix to form an anti-corrosion coating, so as to improve the durability of the cement-based material; in a specific example, the composite emulsion is added at preferably 300 g/m² to 1000 g/m², more preferably 400 g/m² to 600 g/m².

The technical solutions of the present disclosure will be described below clearly and completely in conjunction with the examples of the present disclosure.

### EXAMPLE 1

1) 280 mg of ammonium persulfate was added to 10 g of deionized water to prepare an initiator aqueous solution;
2) 6 g of styrene, 6 g of methyl methacrylate, 8 g of butyl acrylate, and 4 g of acrylic acid were mixed, and then 5 g of the initiator aqueous solution was added to prepare a styrene-acrylic monomer mixture;
3) 480 mg of a GO powder was added into 20 g of deionized water, subjected to ultrasonic dispersion for 2 h, and then added with 1 g of sodium bicarbonate to prepare a GO buffer;
4) 24 g of the styrene-acrylic monomer mixture was slowly added to 21.48 g of the GO buffer, stirred at 150 r/min for 30 min at 80° C., and subjected to ultrasonic dispersion for 3 h to obtain a styrene-acrylic Pickering emulsion;
5) 50 mg of a KH-570 silane coupling agent was added dropwise to the styrene-acrylic Pickering emulsion, stirred at 150 r/min for 20 min at 60° C., and subjected to ultrasonic dispersion at 60° C. for 2 h to obtain a GO-modified styrene-acrylic Pickering emulsion;
6) 0.5 g of OP-10, 0.3 g of Span 80, and 0.3 g of sodium dodecyl sulfate were added into 25 g of deionized water, a mixed solution containing 5 g of vinyltriethoxysilane, 20 g of octyltriethoxysilane, and 3 g of hydroxyethyl acrylate was slowly added, and a mixture was stirred at 1,000 r/min for 2 h at 40° C. to obtain a shell phase emulsion;
7) according to a mass ratio (core-shell ratio) of 1:1, the shell phase emulsion was slowly added into the GO-modified styrene-acrylic Pickering emulsion, and added with 5 g of the initiator aqueous solution; a mixture was stirred at 100 r/min for 2 h at 83° C. and subjected to heat preservation for 2 h, and then slowly cooled to 30° C.; and
8) the emulsion obtained in step 7) was subjected to repeated low-speed stirring and ultrasonic dispersion for 3 times separately, to obtain a styrene-acrylic-siloxane Pickering composite emulsion with a GO content of 2%; where each low-speed stirring was conducted at 100 r/min for 1 h, each ultrasonic dispersion is conducted for 40 min; and the GO content was measured by a mass fraction of the GO in the styrene-acrylic monomer mixture in step 4).

### EXAMPLE 2

1) 280 mg of ammonium persulfate was added to 10 g of deionized water to prepare an initiator aqueous solution;
2) 6 g of styrene, 7 g of methyl acrylate, 7 g of butyl methacrylate, and 4 g of methacrylic acid were mixed, and then 5 g of the initiator aqueous solution was added to prepare a styrene-acrylic monomer mixture;
3) 960 mg of a GO powder was added into 20 g of deionized water, subjected to ultrasonic dispersion for 2 h, and then added with 1 g of sodium carbonate to prepare a GO buffer;
4) 24 g of the styrene-acrylic monomer mixture was slowly added to 21.96 g of the GO buffer, stirred at 150 r/min for 30 min at 80° C., and subjected to ultrasonic dispersion for 3 h to obtain a styrene-acrylic Pickering emulsion;
5) 100 mg of a KH-560 silane coupling agent was added dropwise to the styrene-acrylic Pickering emulsion, stirred at 150 r/min for 20 min at 60° C., and subjected to ultrasonic dispersion for 2 h to obtain a GO-modified styrene-acrylic Pickering emulsion;
6) 0.6 g of OP-10, 0.3 g of Tween 80, and 0.2 g of sodium dodecyl sulfonate were added into 25 g of deionized water, a mixed solution containing 5 g of vinyltriethoxysilane, 20 g of octyltriethoxysilane, and 3 g of hydroxypropyl acrylate was slowly added, and a mixture was stirred at 1,000 r/min for 2 h at 40° C. to obtain a shell phase emulsion;
7) according to a mass ratio of 1:1, the shell phase emulsion was slowly added into the GO-modified styrene-acrylic Pickering emulsion, and added with 5 g of the initiator aqueous solution; a mixture was stirred at 100 r/min for 2 h at 83° C. and subjected to heat preservation for 2 h, and then slowly cooled to 30° C.; and
8) the emulsion obtained in step 7) was subjected to repeated low-speed stirring and ultrasonic dispersion for 3 times separately, to obtain a styrene-acrylic-siloxane Pickering composite emulsion with a GO content of 4%; where each low-speed stirring was conducted at 100 r/min for 1 h, each ultrasonic dispersion is conducted for 40 min; and the GO content was measured by a mass fraction of the GO in the styrene-acrylic monomer mixture in step 4).

### EXAMPLE 3

1) 280 mg of ammonium persulfate was added to 10 g of deionized water to prepare an initiator aqueous solution;
2) 5 g of styrene, 5 g of methyl methacrylate, 9 g of ethyl acrylate, and 5 g of acrylic acid were mixed, and then 5 g of the initiator aqueous solution was added to prepare a styrene-acrylic monomer mixture;
3) 1.44 g of a GO powder was added into 20 g of deionized water, subjected to ultrasonic dispersion for 2 h, and then added with 1 g of sodium hydrogen phosphate to prepare a GO buffer;
4) 24 g of the styrene-acrylic monomer mixture was slowly added to 22.44 g of the GO buffer, stirred at 150 r/min for 30 min at 80° C., and subjected to ultrasonic dispersion for 3 h to obtain a styrene-acrylic Pickering emulsion;
5) 150 mg of a KH-550 silane coupling agent was added dropwise to the styrene-acrylic Pickering emulsion, stirred at 150 r/min for 20 min at 60° C., and subjected to ultrasonic dispersion for 2 h to obtain a GO-modified styrene-acrylic Pickering emulsion;
6) 0.5 g of OP-10, 0.4 g of Span 60, and 0.4 g of sodium dodecyl sulfonate were added into 25 g of deionized water, a mixed solution containing 5 g of vinyltriethoxysilane, 20 g of dodecyltriethoxysilane, and 3 g of hydroxyethyl methacrylate was slowly added, and a mixture was stirred at 1,000 r/min for 2 h at 40° C. to obtain a shell phase emulsion;
7) according to a mass ratio of 1:1, the shell phase emulsion was slowly added into the styrene-acrylic Pickering emulsion, and added with 5 g of the initiator aqueous solution; a mixture was stirred at 100 r/min for 2 h at 83° C. and subjected to heat preservation for 2 h, and then slowly cooled to 30° C.; and
8) the emulsion prepared in step 7) was subjected to repeated low-speed stirring and ultrasonic dispersion for 3 times separately, to obtain a styrene-acrylic-siloxane Pickering composite emulsion with a GO content of 6%; where each low-speed stirring was conducted at 100 r/min for 1 h, each ultrasonic dispersion is conducted for 40 min; and the GO content was measured by a mass fraction of the GO in the styrene-acrylic monomer mixture in step 4).

### EXAMPLE 4

1) 280 mg of ammonium persulfate was added to 10 g of deionized water to prepare an initiator aqueous solution;
2) 4 g of styrene, 8 g of methyl acrylate, 8 g butyl acrylate, and 4 g of methacrylic acid were mixed, and then 5 g of the initiator aqueous solution was added to prepare a styrene-acrylic monomer mixture;
3) 1.92 g of a GO powder was added into 20 g of deionized water, subjected to ultrasonic dispersion for 2 h, and then added with 1 g of sodium bicarbonate to prepare a GO buffer;
4) 24 g of the styrene-acrylic monomer mixture was slowly added to 22.92 g of the GO buffer, stirred at 150 r/min for 30 min at 80° C., and subjected to ultrasonic dispersion for 3 h to obtain a styrene-acrylic Pickering emulsion;
5) 200 mg of a KH-570 silane coupling agent was added dropwise to the styrene-acrylic Pickering emulsion, stirred at 150 r/min for 20 min at 60° C., and subjected to ultrasonic dispersion for 2 h to obtain a GO-modified styrene-acrylic Pickering emulsion;
6) 0.5 g of OP-10, 0.25 g of Tween 60, and 0.35 g of sodium dodecyl benzenesulfonate were added into 25 g of deionized water, a mixed solution containing 5 g of vinyltriethoxysilane, 25 g of octyltrimethoxysilane, and 3 g of hydroxypropyl methacrylate was slowly added, and a mixture was stirred at 1,000 r/min for 2 h at 40° C. to obtain a shell phase emulsion;
7) according to a mass ratio of 1:1, the shell phase emulsion was slowly added into the styrene-acrylic Pickering emulsion, and added with 5 g of the initiator aqueous solution; a mixture was stirred at 100 r/min for 2 h at 83° C. and subjected to heat preservation for 2 h, and then slowly cooled to 30° C.; and
8) the emulsion prepared in step 7) was subjected to repeated low-speed stirring and ultrasonic dispersion for 3 times separately, to obtain a styrene-acrylic-siloxane Pickering composite emulsion with a GO content of 8%; where each low-speed stirring was conducted at 100 r/min for 1 h, each ultrasonic dispersion is conducted for 40 min; and the GO content was measured by a mass fraction of the GO in the styrene-acrylic monomer mixture in step 4).

### Comparative Example 1

In this comparative example, a core-shell emulsion was prepared by a method similar to that of Example 1, except that step 3) and step 5) were omitted, and step 4) was changed to:
a styrene-acrylic monomer mixture was added to a pH buffer aqueous solution (specifically, a sodium hydroxide solution with a concentration of 5 wt %) and stirred at 83° C. for 3 h to prepare a styrene-acrylic core phase emulsion; and the styrene-acrylic core phase emulsion was used to replace the styrene-acrylic Pickering emulsion in step 7);
step (8) was omitted.

The remaining conditions were the same as those in Example 1, and finally a styrene-acrylic-siloxane composite core-shell emulsion was obtained.

### Comparative Example 2

In this comparative example, a GO-modified copolymer emulsion was prepared by a method similar to that of Example 1, except that step 4) and step 5) were omitted;
since the emulsion obtained in Comparative Example 2 had no core-shell structure, the emulsion prepared according to step 6) of Example 1 was recorded as a siloxane pre-emulsion;
step 7) was changed to: the GO buffer, the styrene-acrylic monomer mixture, and the siloxane pre-emulsion (the GO buffer, the styrene-acrylic monomer mixture, and the siloxane pre-emulsion each had a dosage the same as that in Example 1), and added with 5 g of the initiator aqueous solution; a mixture was stirred at 100 r/min for 2 h at 83° C. and subjected to heat preservation for 2 h, and then slowly cooled to 30° C.; and
the remaining conditions were the same as those in Example 1, and finally a modified styrene-acrylic-siloxane copolymer emulsion with a GO content of 2% was prepared.

### Comparative Example 3

In this comparative example, a GO-modified styrene-acrylic-siloxane copolymer emulsion was prepared by a method similar to that of Comparative Example 2, except that the GO content was 8%, that is, the amount of GO in step 7) was 8% of a mass of the styrene-acrylic monomer mixture; finally, a modified styrene-acrylic-siloxane copolymer emulsion with a GO content of 8% was prepared.

### Performance Testing

### (1) Appearance and Microscope Test

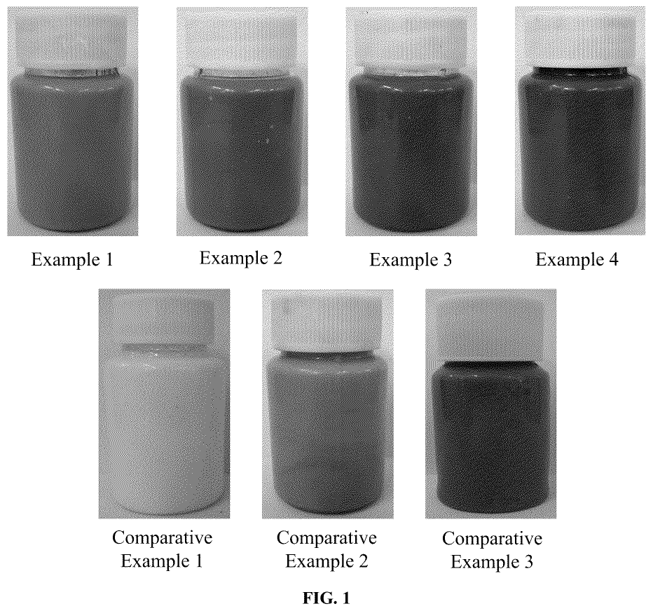

FIG. 1 showed optical photographs of an apparent form of composite emulsions obtained in Example 1 to 4 and Comparative Examples 1 to 3. According to FIG. 1, it was seen that the GO-modified styrene-acrylic-siloxane Pickering composite emulsions prepared in Examples 1 to 4 each had desirable homogeneity and stability; the emulsion had no flocculation, delamination, or segregation, and the GO sheets on an outer surface of the Pickering structure were not agglomerated. However, the composite emulsions prepared in Comparative Examples 1 to 3 each had uneven color and slight agglomeration.

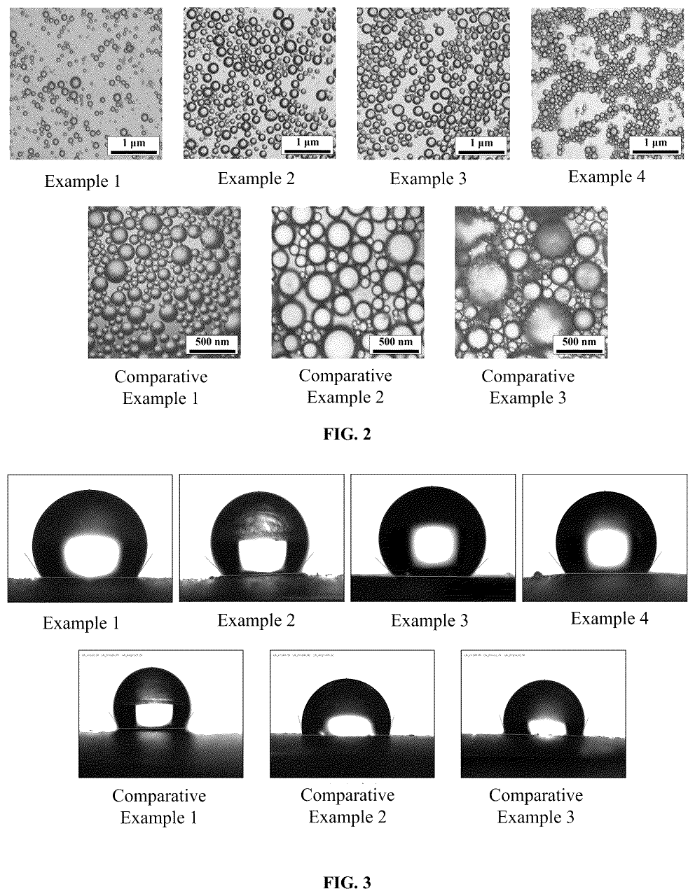

FIG. 2 showed metallographic microscope scanning images of the composite emulsions obtained in Example 1 to 4 and Comparative Examples 1 to 3. As shown in FIG. 2, the composite emulsions in Examples 1 to 4 each had a latex particle size less than that of the core-shell emulsion and the copolymer emulsion in Comparative Example 1 to 3; and the composite emulsions obtained in Examples 1 to 4 each had a relatively uniform particle size. However, in the emulsions obtained in Comparative Examples 1 to 3, the latex particles had a relatively-dispersed particle size distribution. A smaller particle size of the emulsion leads to a larger specific surface area of the latex particles, and a higher the content of wrapped and adsorbed GO sheets in the Pickering structure. Therefore, the preparation method of the Pickering emulsion of the present disclosure can significantly improve the utilization rate and dispersibility of GO.

### (2) Test of Basic Properties of Emulsion

According to GB/T1728-2020 “Determination of drying time of coating and putty films”, the surface drying time and actual drying time of the composite emulsion coating were determined by a finger touch method. The emulsion was put into a weighing bottle, dried in an oven at 105° C. for 3 h, and then cooled to a room temperature in a desiccator; and a mass of the emulsion was weighed before and after drying and recorded as m₁ and m₂ separately. The emulsion was filtered with a 200-mesh copper mesh, all gels were collected and cleaned with deionized water; the gels were dried by a same method, and a mass of the dried gel was recorded as m₃. In addition, the emulsion was demulsified with ethanol, and a resulting precipitated solid was washed several times with deionized water and dried at 80° C. for 6 h. The precipitated solid was extracted according to the GB/T 23530-2009 standard, and weights before and after extraction were measured and recorded as m₄ and m₅, respectively. The calculation formulas of a solid content, a gel rate, a monomer conversion rate, and a grafting rate were as follows:

$$Solid content = {m}_{2} / {m}_{1}$$

$$Gel rate = {m}_{3} / {m}_{1}$$

$$Monomer conversion rate = ( {m}_{2} - {m}_{n o n} ) / {m}_{M}$$

$$Grafting rate = - \frac{{m}_{5} - {m}_{4} \times {p}_{S E}}{{m}_{4} ( 1 - {p}_{S E} )}$$

mₙₒₙ was a mass of non-volatile matter (that is, a total mass of other raw materials except solvent water), m_{M} was a mass of all organic monomers in the raw materials, and p_{SE} was a mass fraction of silane monomer in the composite emulsion.

Results were shown in Table 1:

TABLE 1
Basic performance parameters of composite emulsions obtained
in Examples 1 to 4 and Comparative Examples 1 to 3

| | | | | | Comparative | Comparative | Comparative |
|---|---|---|---|---|---|---|---|
| | Example 1 | Example 2 | Example 3 | Example 4 | Example 1 | Example 2 | Example 3 |
| Surface dry | 6 h | 6 h | 6 h | 8 h | 6 h | 6 h | 8 h |
| time | | | | | | | |
| Hard dry time | 12 h | 12 h | 14 h | 16 h | 12 h | 14 h | 14 h |
| Solid content | 42.8% | 45.7% | 47.9% | 47.6 | 49.7% | 43.3% | 44.1% |
| Gelation rate | 1.1% | 1.0% | 0.7% | 0.9% | 1.4% | 1.6% | 1.5% |
| Monomer | 90.3% | 89.1% | 88.3% | 84.2% | 86.7% | 86.7% | 87.2% |
| conversion rate | | | | | | | |
| Grafting rate | 87.8% | 88.5% | 89.6% | 89.7% | 86.6% | 84.3% | 85.8% |

As shown in Table 1, the composite emulsions obtained in Examples 1 to 4 had no significant difference in the surface drying time and the actual drying time with those of the emulsions in Comparative Examples 1 to 3. Compared with Comparative Examples 1 to 3, the GO-modified styrene-acrylic-siloxane Pickering composite emulsion had a higher solid content and a lower gel ratio. In addition, the emulsions of Examples 1 to 4 each had higher monomer conversion rate and grafting rate. It indicated that the GO-modified Pickering structure could significantly promote the polymerization between the styrene-acrylic core structure and the siloxane shell structure, and enhance the cross-linking and bonding between the styrene-acrylic component, the GO interface, and the siloxane component.

### (3) Test of Emulsion Stability

The composite emulsions prepared in Examples 1 to 4 and Comparative Examples 1 to 3 were used as test objects, and the following test was conducted: the emulsion was diluted with deionized water as a solvent to a concentration of 2% to observe the dilution stability of the emulsion;
the emulsion was centrifuged for 5 min in a centrifuge at a rotational speed of 2,000 r/min to observe the centrifugal stability of the emulsion;
the emulsion was diluted with a 5% CaCl₂ solution to a concentration of 10% to observe the Ca²⁺ stability;
the emulsion was allowed to stand at 60° C. for 24 h to observe the high-temperature stability of the emulsion; and
the emulsion was allowed to stand at 0° C. for 18 h to observe the low-temperature stability of the emulsion.

Results were shown in Table 2:

TABLE 2
Stability of composite emulsion of each experimental group

| | | | | | Comparative | Comparative | Comparative |
|---|---|---|---|---|---|---|---|
| | Example 1 | Example 2 | Example 3 | Example 4 | Example 1 | Example 2 | Example 3 |
| Centrifugal | Relatively | Excellent | Excellent | Relatively | Relatively | Relatively | Relatively |
| stability | excellent | | | excellent | excellent | poor | poor |
| Dilution stability | Excellent | Excellent | Excellent | Excellent | Excellent | Relatively | Relatively |
| | | | | | | excellent | excellent |
| Ca²⁺ stability | Excellent | Excellent | Excellent | Relatively | Excellent | Relatively | Poor |
| | | | | excellent | | poor | |
| Low-temperature | Relatively | Relatively | Relatively | Relatively | Relatively | Poor | Poor |
| stability | excellent | excellent | excellent | excellent | poor | | |
| High-temperature | Excellent | Excellent | Excellent | Excellent | Excellent | Relatively | Relatively |
| stability | | | | | | excellent | poor |

In Table 2: Excellent meant that the composite emulsion could still maintain high stability after standing for 14 d, and the appearance of the emulsion basically did not change. Relatively excellent meant that the composite emulsion initially had a relatively high stability, but after standing for 14 d, the emulsion slightly aggregated, gelled, delaminated, and segregated. Relatively poor meant that the composite emulsion had slight agglomeration, gelation, delamination, or segregation at the beginning, and after standing for 14 d, the stability of the emulsion was further reduced, and more serious coagulation or delamination occurred. Poor meant that the composite emulsion exhibited severe coagulation or delamination at the beginning

### (4) Particle Size Distribution and Dispersibility of Emulsion

The particle size distribution and Zeta potential of the emulsions in Examples 1 to 4 and Comparative Examples 1 to 3 were shown in Table 3:

TABLE 3
Particle size distribution and Zeta potential of composite emulsions
in Examples 1 to 4 and Comparative Examples 1 to 3

| | | | | | Comparative | Comparative | Comparative |
|---|---|---|---|---|---|---|---|
| | Example 1 | Example 2 | Example 3 | Example 4 | Example 1 | Example 2 | Example 3 |
| Average droplet | 177 | 186 | 218 | 231 | 168 | 137 | 151 |
| size/nm | | | | | | | |
| PDI | 0.304 | 0.316 | 0.338 | 0.345 | 0.288 | 0.264 | 0.251 |
| Zeta potential/-mV | 45.31 | 46.87 | 47.12 | 48.05 | 41.38 | 38.92 | 36.03 |

As shown from the data in Table 3, the composite emulsions obtained in Examples 1 to 4 each had an average particle size of less than 250 nm, which was higher than that of the core-shell emulsion and copolymer emulsion in Comparative Examples 1 to 3, satisfying the basic requirements of penetrating protective emulsions. The composite emulsions obtained in Examples 1 to 4 each had a PDI homogeneity index of less than 0.35, which was still higher than that in Comparative Examples 1 to 3. This also reflected that the molecular weight distribution of the composite emulsion prepared by the present disclosure had a relatively high discreteness, which was also one of the notable features of the GO-modified Pickering emulsion. The absolute values of Zeta potentials of the composite emulsions obtained in Examples 1 to 4 were significantly higher than those in Comparative Examples 1 to 3, indicating that the Pickering structure had superior dispersibility. The absolute value of the Zeta potential of Example 4 reached a maximum, indicating that an increase of the interface GO content in the Pickering structure was conducive to an improvement of the stability of the Pickering emulsion.

### (4) Hydrophobic and Waterproof Properties of Emulsion

The GO-modified styrene-acrylic-siloxane Pickering composite emulsion prepared in Examples 1 to 4 and the emulsions prepared in Comparative Examples 1 to 3 were coated on the surface of a cement paste specimen twice at an amount of 600 g/m², with an interval of no less than 6 h between the two times, and a static water contact angle test was conducted after drying.

Static water contact angle test: the static water contact angle on the surface of the cement paste specimens of each experimental group was measured by a surface contact angle measuring instrument. The test figure of the obtained static contact angle was shown in FIG. 3, and the specific data of the contact angle was shown in Table 4.

TABLE 4
Static contact angles on surfaces of cement specimens of each experimental group

| | | | | | Comparative | Comparative | Comparative |
|---|---|---|---|---|---|---|---|
| | Example 1 | Example 2 | Example 3 | Example 4 | Example 1 | Example 2 | Example 3 |
| Contact | 124.85 | 133.16 | 136.02 | 127.56 | 123.93 | 104.22 | 110.40 |
| angle/° | | | | | | | |

It was seen from FIG. 3 and Table 4 that compared with Comparative Examples 1 to 3, the films formed by the emulsions prepared in Examples 1 to 4 each had a larger surface contact angle, exhibiting higher hydrophobic properties. It showed that the hydrophobic property of the coating formed by the composite emulsion prepared by the present disclosure was better than that of the core-shell emulsion and the GO-modified copolymer emulsion, indicating that the emulsification substitution and interface modification of GO in Pickering emulsion could significantly improve the hydrophobicity of the coating.

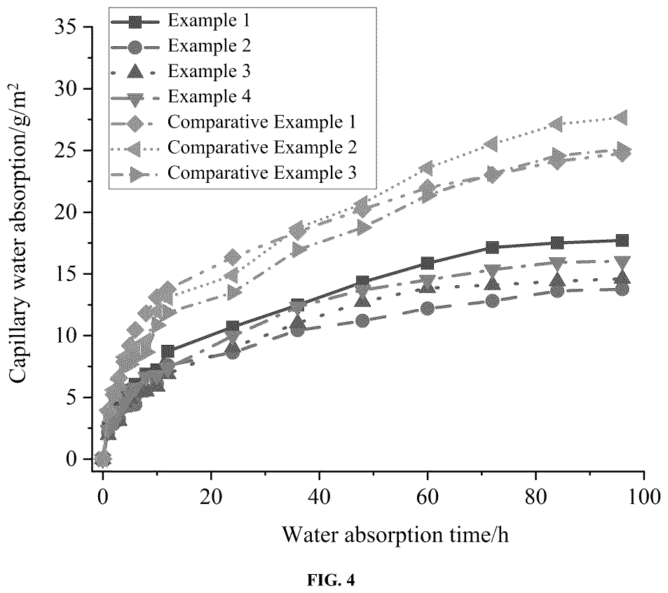

Static water absorption test: a non-poured surface of a dry concrete specimen was used as a coating surface, and the emulsion was coated on the surface of the cement paste specimen twice according to the amount of 600 g/m², with an interval of not less than 6 h between the two times, and a side surface was sealed with a curing glue. The concrete specimen was placed in distilled water, and a coated surface was about 0.5 cm away from a water surface, and a variation law of the static capillary water absorption of the concrete specimen with the penetration time was measured. The results were shown in FIG. 4 and table 5, where FIG. 4 was a static capillary water absorption curve of the concrete specimens of each experimental group; Table 5 showed the static capillary water absorption data of concrete in each experimental group for 24 h.

TABLE 5
Static capillary water absorption of concrete in each experimental group for 24 h (g · m⁻² h^{-0.5})

| | | | | | Comparative | Comparative | Comparative |
|---|---|---|---|---|---|---|---|
| | Example 1 | Example 2 | Example 3 | Example 4 | Example 1 | Example 2 | Example 3 |
| Capillary water | 12.4 | 9.7 | 10.3 | 11.4 | 15.4 | 17.2 | 15.9 |
| absorption rate | | | | | | | |

As was seen from FIG. 4 and Table 5, compared with the concrete specimens coated with the common core-shell emulsions and GO-modified copolymer emulsions of Comparative Examples 1 to 3, the concrete specimen treated with the GO-modified Pickering composite emulsion prepared by the present disclosure had greatly-reduced static capillary water absorption. Compared with the capillary water absorption in Comparative Example 1, Examples 1 to 4 were decreased by 19.5%, 37.0%, 33.1%, and 25.9%, respectively, where the static capillary water absorption of Example 2 was obviously decreased. It showed that the preparation method of the present disclosure could maximize the interface modification performance of GO to the styrene-acrylic-siloxane core-shell structure, thereby improving the film-forming performance and protective performance of Pickering emulsion on the surface of cement-based materials, and inhibiting diffusion and transport of water molecules in concrete.

### (5) Anti-Chlorine Salt Erosion and Anti-Sulfate Erosion Performances

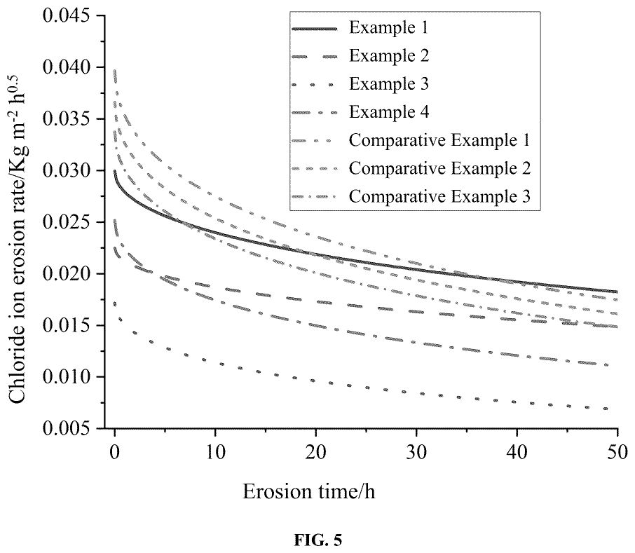

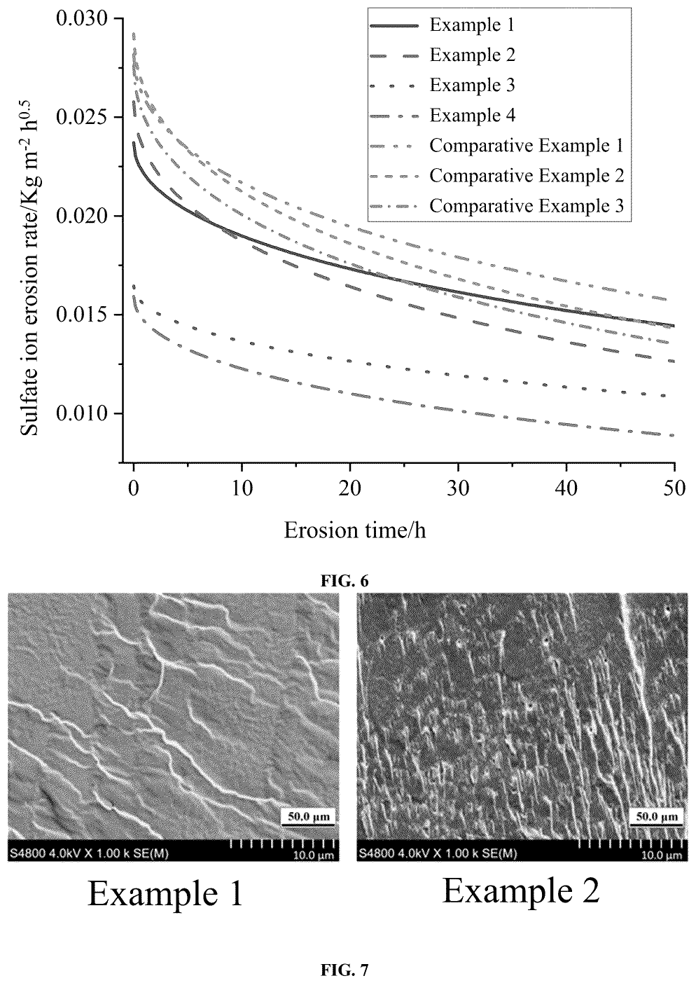

By the same method as the static water absorption test, one non-poured surface of the dry concrete specimen was used as the coating surface, and the side surface was sealed with a curing glue; the specimens were immersed in 10% NaCl and Na₂SO₄ solutions to test the penetration of chloride ions and sulfate ions in the concrete specimens. The results were shown in FIG. 5 to FIG. 6, where FIG. 5 showed a calculation fitting diagram of an erosion rate on concrete by chloride ions in each experimental group; FIG. 6 showed a calculation fitting diagram of an erosion rate on concrete by sulfate ions in each experimental group.

It was seen from FIG. 5 and FIG. 6 that compared with Comparative Examples 1 to 3, in the concrete specimens treated with GO-modified styrene-acrylic-siloxane Pickering composite emulsion in Examples 1 to 4, the erosion rates of chloride ions and sulfate ions had been reduced to varying degrees. This showed that the ion permeation resistance of the styrene-acrylic component and the siloxane component was significantly improved by constructing a Pickering structure with a GO interface. During the entire erosion, the erosion rates of chloride and sulfate ions were relatively stable, indicating that the styrene-acrylic-siloxane Pickering emulsion connected by the GO interface could effectively inhibit the diffusion and transport of erosion ions in the capillary channels of concrete, thereby blocking the transmission path of eroding ions and reducing the osmotic pressure of ions in capillary channels.

(6) Acid and Alkali Resistances of latex film

The latex film was prepared by using the emulsions prepared in each experimental group. A specific preparation method included: the emulsion was poured into a polytetrafluoroethylene strip mold, dried at 40° C. for 48 h, and demould to form a latex film sample with a size of 15 mm×50 mm×3 mm. The latex film was soaked in a dilute hydrochloric acid solution with pH=3 and a sodium hydroxide solution with pH=12 for 72 h separately, and a mass loss rate was measured. The results were shown in Table 6.

TABLE 6
Mass loss rate of latex film in each experimental group under acid-base corrosion

| | | | | | Comparative | Comparative | Comparative |
|---|---|---|---|---|---|---|---|
| | Example 1 | Example 2 | Example 3 | Example 4 | Example 1 | Example 2 | Example 3 |
| Acid | 38% | 36% | 32% | 29% | 42% | 47% | 40% |
| corrosion | | | | | | | |
| Alkali | 19% | 17% | 17% | 16% | 24% | 22% | 18% |
| corrosion | | | | | | | |

As shown in Table 6, the latex films of Examples 1 to 4 under acid-base corrosion had mass loss rates less than those of Comparative Examples 1 to 3, indicating that the coating formed by the composite emulsion synthesized by the preparation method of the present disclosure had more superior resistance to acid and alkali corrosion. The latex film of Example 4 had the minimum mass loss rate, indicating that a higher interface GO content was beneficial to the improvement of acid and alkali corrosion resistance of the Pickering emulsion coating.

A cement test specimen was prepared according to a same method as that in the static water absorption test; and by a same experimental method as the mass loss rate, the coating on the surface of the cement test specimen was corroded. With a bond strength detector and a pencil hardness tester, the surface bonding adhesion strength and pencil hardness of the composite coating on a surface of the cement specimen after acid-base corrosion for 72 h were measured. The results were shown in Table 7:

TABLE 7
Bonding adhesion strength and pencil hardness of coatings on surface of
cement specimens of each experimental group under acid-base corrosion

| | | | | | | |
|---|---|---|---|---|---|---|
| | | | | Comparative | Comparative | Comparative |
| Example 1 | Example 2 | Example 3 | Example 4 | Example 1 | Example 2 | Example 3 |

Surface adhesion strength/MPa

| | | | | | | | |
|---|---|---|---|---|---|---|---|
| Acid corrosion | 3.6 | 3.6 | 3.8 | 3.9 | 3.6 | 2.8 | 3.0 |
| Alkali corrosion | 5.5 | 5.7 | 5.7 | 5.9 | 6.2 | 4.8 | 5.1 |

Pencil hardness

| | | | | | | | |
|---|---|---|---|---|---|---|---|
| Acid corrosion | B | B | B | B | B | 2B | 3B |
| Alkali corrosion | B | HB | HB | HB | B | B | 2B |

It was seen from Table 7 that compared with the core-shell emulsions and GO-modified copolymer emulsions in the comparative examples, the composite emulsions prepared in Examples 1 to 4 under acid-base corrosion each had a higher surface bonding adhesion strength with cement-based materials. Under acid-base corrosion, the pencil hardness of the latex film in each comparative example was low, while the pencil hardness of each coating in Examples 1 to 4 was improved to varying degrees. Example 4 had the highest surface bonding adhesion strength and the highest pencil hardness, showing excellent acid and alkali corrosion resistance.

### (7) Anti-Aging Performance of Latex Film

The latex film was prepared by the emulsion prepared by each experimental group (a preparation method was the same as that in the mass loss rate test), and the obtained latex film was placed under artificial ultraviolet light with an irradiance of 50 w/m² and a wavelength of 254 nm for 72 h, to measure the surface gloss loss rate and crosslink density loss rate. The results were shown in Table 8.

In addition, the latex film prepared by each experimental group was placed in a xenon arc aging test box and aged at 70° C. for 144 h to measure the loss rate of tensile strength and elongation at break. The results were shown in Table 9.

TABLE 8
Crosslinking density loss rate/% of latex film of each experimental group

| | | | | | Comparative | Comparative | Comparative |
|---|---|---|---|---|---|---|---|
| | Example 1 | Example 2 | Example 3 | Example 4 | Example 1 | Example 2 | Example 3 |
| Crosslinking | 15.2% | 15.8% | 14.3% | 12.6% | 17.6% | 19.3% | 17.7% |
| density loss rate | | | | | | | |

TABLE 9
Loss rate/% of tensile strength and elongation at break of latex film in each experimental group

| | | | | | Comparative | Comparative | Comparative |
|---|---|---|---|---|---|---|---|
| | Example 1 | Example 2 | Example 3 | Example 4 | Example 1 | Example 2 | Example 3 |
| Tensile strength | 21.8 | 19.7 | 17.5 | 16.4 | 22.7 | 33.5 | 29.9 |
| Elongation at | 22.2 | 24.2 | 20.4 | 20.8 | 28.7 | 42.5 | 38.8 |
| break | | | | | | | |

It was seen from Table 8 that the crosslinking density loss rate of the composite emulsion coatings of Examples 1 to 4 was significantly lower than that of Comparative Examples 1 to 3, showing superior anti-ultraviolet aging performances. In addition, the loss rates of tensile strength and elongation at break of the coatings obtained in Examples 1 to 4 were also significantly lower than those of Comparative Examples 1 to 3, especially the elongation at break of the latex film after aging had been significantly improved. Example 4 had the lowest loss rate of crosslinking density, loss rate of tensile strength, and loss rate of elongation at break, indicating that the increase of interface GO content was beneficial to improvement of the anti-ultraviolet aging performance and heat aging resistance of the Pickering emulsion coating.

### (8) SEM and AFM Observation of Latex Film

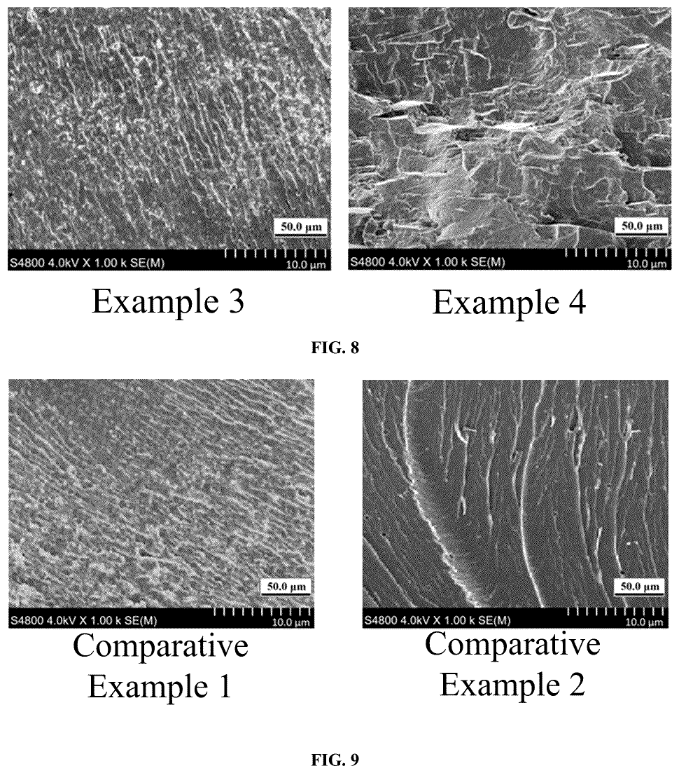

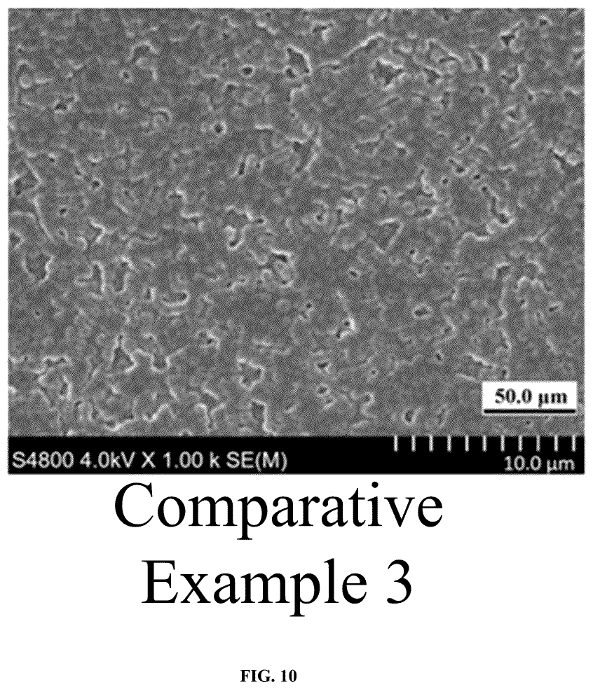

FIG. 7 to FIG. 10 showed SEM test figures of latex films formed by the emulsions in Examples 1 to 4 and Comparative Examples 1 to 3; and

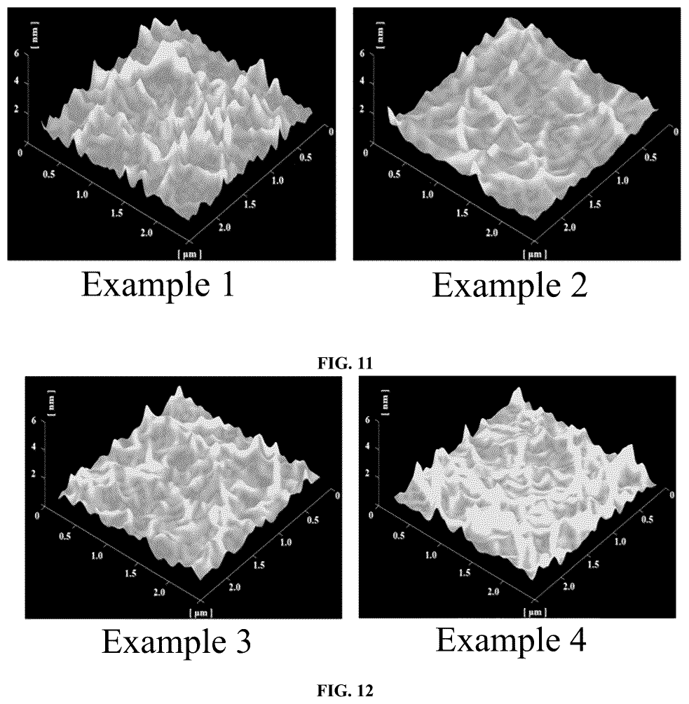

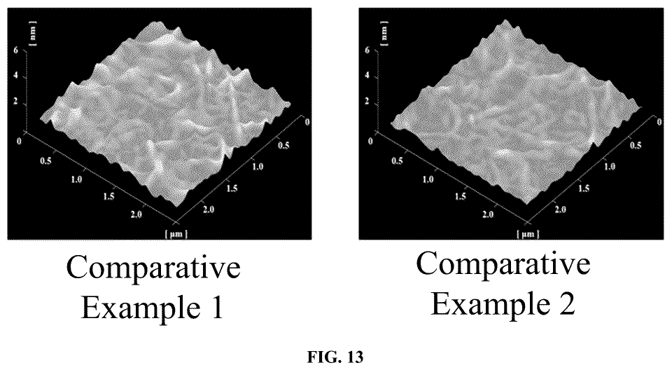

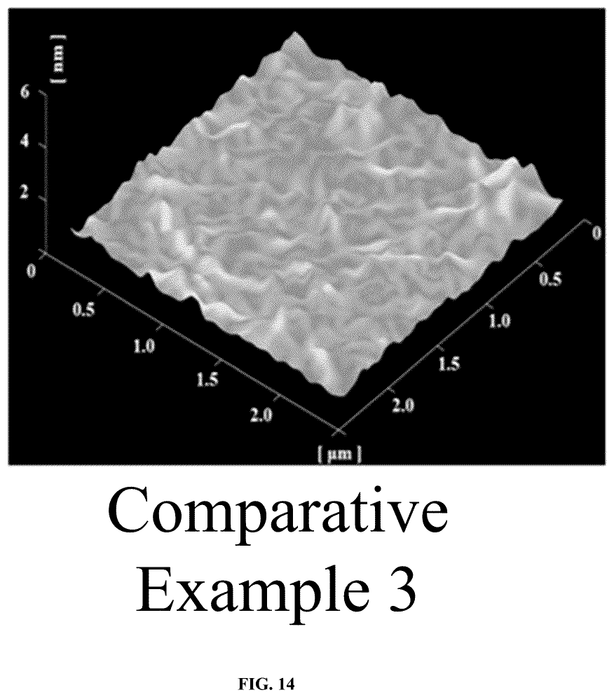

FIG. 11 to FIG. 14 showed AFM test figures of latex films formed by the emulsions in Examples 1 to 4 and Comparative Examples 1 to 3.

It was seen from FIG. 7 to FIG. 14 that the surface roughness of the latex films formed in Examples 1 to 4 was significantly higher than that of the latex films of the common core-shell emulsion coatings and the copolymer emulsion coatings in the comparative examples. The latex films formed by the emulsions obtained in Examples 1 to 4 contained less surface pores and had a typical scaly surface appearance. It proved that the preparation method of the present disclosure could significantly enhance the surface roughness and structural compactness of the composite coating, and further helped to improve the waterproof performance and ion erosion resistance of the composite anticorrosion coating.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A preparation method of a graphene oxide (GO)-modified styrene-acrylic Pickering emulsion, comprising the following steps:
mixing a GO buffer with a styrene-acrylic monomer mixture to conduct first ultrasonic dispersion, and mixing an obtained emulsion with a silane coupling agent to conduct second ultrasonic dispersion, to obtain the GO-modified styrene-acrylic Pickering emulsion; wherein the GO buffer comprises GO, water, and a pH buffer; and the styrene-acrylic monomer mixture comprises water, an initiator, styrene, and an acrylate monomer.

2. The preparation method according to claim 1, wherein the styrene-acrylic monomer mixture has 0.3% to 0.7% of the initiator, 10% to 30% of the styrene, and 60% to 90% of the acrylate monomer by mass fraction.

3. The preparation method according to claim 1 or 2, wherein in the styrene-acrylic monomer mixture, the initiator is one or more selected from the group consisting of a persulfate and an azo initiator.

4. The preparation method according to claim 1, wherein the GO buffer has the GO with a mass 1% to 10% that of the styrene-acrylic monomer mixture and water with a mass 60% to 150% that of the styrene-acrylic monomer mixture, and has a pH value of 7 to 8.5.

5. The preparation method according to claim 1, wherein the pH buffer is one or more selected from the group consisting of sodium bicarbonate, sodium carbonate, sodium hydrogen phosphate, a Barbitone buffer, Trometamol, and a glycerophosphate buffer.

6. The preparation method according to claim 1, wherein the first ultrasonic dispersion is conducted at 30° C. to 60° C. for 1 h to 3 h.

7. The preparation method according to claim 1, wherein the second ultrasonic dispersion is conducted at 55° C. to 75° C. for 0.5 h to 2 h.

8. A GO-modified styrene-acrylic Pickering emulsion prepared by the preparation method according to any one of claims 1 to 7, having a GO-modified styrene-acrylic Pickering structure, and comprising a styrene-acrylic core and GO wrapped at an outer interface of the styrene-acrylic core, wherein the GO is coupled by a coupling agent.

9. A preparation method of a GO-modified styrene-acrylic-siloxane Pickering composite emulsion, comprising the following steps:
mixing a shell phase emulsion, the GO-modified styrene-acrylic Pickering emulsion according to claim 8, and an initiator aqueous solution, and conducting polymerization to obtain the GO-modified styrene-acrylic-siloxane Pickering composite emulsion; wherein the shell phase emulsion comprises a silane monomer, an acrylate functional monomer, an emulsifier, and water.

10. The preparation method according to claim 9, wherein the shell phase emulsion has 20% to 50% of the silane monomer by mass fraction; the acrylate functional monomer has a mass 10% to 50% that of the silane monomer, and the emulsifier has a mass 2% to 5% a total mass of the silane monomer and the acrylate functional monomer.

11. The preparation method according to claim 9, wherein a preparation method of the shell phase emulsion comprises: mixing the silane monomer, the acrylate functional monomer, and the emulsifier with water, and stirring at a low temperature of 30° C. to 50° C. and a high speed of 800 r/min to 1,200 r/min to obtain the shell phase emulsion.

12. The preparation method according to claim 9, 10, or 11, wherein the silane monomer is a long-chain hydrocarbyl silane; and in the long-chain hydrocarbyl silane, a hydrocarbyl group has 4 to 18 of carbon atoms.

13. The preparation method according to claim 12, wherein the long-chain hydrocarbyl silane is one or more selected from the group consisting of n-butyltriethoxysilane, n-octyltrimethoxysilane, n-octyltriethoxysilane, dodecyltrimethoxysilane, and dodecyltriethoxysilane.

14. The preparation method according to claim 9, 10, or 11, wherein the acrylate functional monomer comprises hydroxyethyl acrylate and/or hydroxypropyl acrylate.

15. The preparation method according to claim 9, 10, or 11, wherein the emulsifier is one or more selected from the group consisting of OP-10, Span 80, sodium dodecyl sulfate, sodium dodecyl sulfonate, and sodium dodecyl benzenesulfonate.

16. The preparation method according to claim 9, wherein the GO-modified styrene-acrylic Pickering emulsion and the shell phase emulsion have a mass ratio of 1:(1-5).

17. The preparation method according to claim 9 or 16, wherein in the initiator aqueous solution, an initiator has a mass 0.2% to 0.5% that of the shell phase emulsion.

18. The preparation method according to claim 9, wherein the polymerization is conducted at a high temperature of 80° C. to 85° C. under stirring at a low speed of 100 r/min to 300 r/min for 1 h to 3 h.

19. The preparation method according to claim 9, further comprising the following steps after the polymerization: conducting low-speed stirring and ultrasonic dispersion 3 to 6 repetitions on the composite emulsion, wherein one time of the low-speed stirring and one time of the ultrasonic dispersion are counted as one repetition.

20. A GO-modified styrene-acrylic-siloxane Pickering composite emulsion prepared by the preparation method according to any one of claims 9 to 19, having a core-shell structure, and comprising a shell structure, a core structure, and an intermediate transition layer connecting the shell structure and the core structure, wherein the shell structure is a siloxane polymer, and the core structure is a GO-modified styrene-acrylic Pickering structure; and the intermediate transition layer is a polymer formed from the acrylate functional monomer.

21. Use of the GO-modified styrene-acrylic-siloxane Pickering composite emulsion according to claim 20 in anticorrosion of a cement-based material.
